(19) United States
(12) Patent Application Publication
(10) Pub. No.: US 2022/0342467 A1
(43) Pub. Date: Oct. 27, 2022

(54) COMPETITIVE POWER ORCHESTRATION AND SCHEDULING

(71) Applicant: Solana Technologies Inc., Vista, CA (US)

(72) Inventors: Kenneth Stanwood, Vista, CA (US); David Gell, San Diego, CA (US)

(73) Assignee: Solana Technologies Inc., Vista, CA (US)

(21) Appl. No.: 17/704,399

(22) Filed: Mar. 25, 2022

Related U.S. Application Data
(60) Provisional application No. 63/178,785, filed on Apr. 23, 2021.

(51) Int. Cl. G06F 1/26; G06F 1/16; G06Q 50/06

(52) U.S. Cl. CPC G06F 1/26; G06F 1/1633; G06Q 50/06

(57) ABSTRACT

A system for the orchestration and scheduling of access to power sources includes a plurality of smart devices, each comprising a resource manager, and a resource orchestrator that communicates with each resource manager, generates a power resource schedule that includes at least one available power block associated with a power source, transmits the schedule to each resource manager of each smart device, receives at least one power request from a resource manager associated with at least one of the smart devices, the at least one power request including a requested available power block and an associated price, allocates the requested available power block to the resource manager that sent the at least one power request, and sends an allocation indication to the resource manager that sent the at least one power request, the allocation indication indicating that the requested available power block has been allocated to the resource manager.

### CROSS REFERENCE TO RELATED APPLICATION

This application claims priority from U.S. Provisional Application No. 63/178,785, filed on Apr. 23, 2021, entitled “COMPETITIVE POWER ORCHESTRATION AND SCHEDULING”, the contents of which are incorporated herein by reference.

### FIELD OF THE INVENTION

This application relates to the orchestration and scheduling of scarce power related resources in a resource competitive environment. Such power related resources may be orchestrated and scheduled for access and use by devices that include, for example, autonomous vehicles, factory robots, autonomous robots, satellite communications systems, satellite payload systems, residential smart devices, medical devices, and battery-supported rechargeable energy powered Internet of Things (IoT) devices.

### BACKGROUND

Electric powered devices are becoming smarter, more autonomous, and increasingly rely on locally stored electricity. Such devices must share and compete for scarce, power-related resources such as an electricity connection or access to a charging station.

A fleet of autonomous vehicles or factory robots may share fewer charging stations than there are vehicles or devices requiring access to the charging stations. Some devices will have more urgent power needs at times when others have less urgent power needs. Scarce power-related resources will be worth more to devices with urgent needs than to those that have less urgent needs. Accordingly, there is a need for management of the availability of charging stations for use by devices and autonomous vehicles, and also a need for autonomous vehicles and factory robots to manage their power reserves and power requirements, especially when power related resources are scarce.

Some satellite systems provide for multiple sub-payloads per satellite. Sub-payloads rely on the host satellite to provide a set of common host functions, including power. A hosted sub-payload may have its own power storage in addition to the host satellite's battery. The multiple hosted sub-payloads may have different purposes and be controlled by different owners. Therefore, they may have different power needs at different times. Hosted sub-payloads on the same host satellite may compete for resources, such as power. Accordingly, there is a need for the host satellite to somehow orchestrate resource availability amongst the various hosted sub-payloads and for a hosted sub-payload to manage its own power resources.

More and more devices, such as smart devices, in the home are becoming connected and able to be controlled remotely, for instance over Wi-Fi or via an application on a smart phone, tablet, or personal computer. This allows the devices to potentially be controlled for power conservation or price reduction. For instance, it is possible to partially, or fully, relinquish control of a home's thermostat to the electric company so that they may raise the target temperature during summer peak hours to reduce the electricity consumed by an air conditioner. Electric companies increase the cost of electricity during peak usage hours, raise the cost of electricity at certain thresholds of usage, and impose rolling brownouts when they expect demand for electricity to exceed production. Accordingly, there is a need for power consuming devices within a house to be managed in order to reduce power consumption during times of increased power cost and/or limited power supply. Also, there is a need for houses to somehow ensure that critical devices such as medical equipment have the power they need to operate correctly and reliably, and also to tradeoff the power consumption between houses based on the needs and tolerances of each house.

### SUMMARY OF THE INVENTION

In an aspect, a resource orchestration system is provided for the orchestration and scheduling of access to available power sources, the resource orchestration system comprising a plurality of smart devices, each smart device comprising a resource manager, and a resource orchestrator that communicates with the resource manager of each smart device, generates a power resource schedule that includes at least one available power block associated with a power source, transmits the power resource schedule to the resource manager of each smart device, receives at least one power request from a resource manager associated with at least one of the plurality of smart devices, the at least one power request including a requested available power block and an associated price, allocates the requested available power block to the resource manager that sent the at least one power request, and sends an allocation indication to the resource manager that sent the at least one power request, the allocation indication indicating that the requested available power block has been allocated to the resource manager.

In another aspect, a smart device is provided that cooperates in the orchestration and scheduling of access to available power sources, the smart device comprising a communication unit, a functional component that utilizes power, and a resource manager that communicates, via the communication unit, with a resource orchestrator, receives a power resource schedule from the resource orchestrator, the power resource schedule including at least one available power block associated with a power source, generates a power request that includes a requested available power block selected from the at least one available power block included in the received power resource schedule, the power request being generated at least in part on a power requirement associated with the functional component of the smart device, sends the power request to the resource orchestrator, receives an allocation indication from the resource orchestrator in the case that resource orchestrator has allocated the requested available power block to the resource manager, and instructs the smart device to access the power source associated with the allocated available power block based on the received allocation indication, wherein the allocated available power block determines an amount of allowed access to the power source by the smart device.

In an aspect, a method is provided for the orchestration and scheduling of access to available power sources, the method comprising the steps of communicating with a resource manager provided in each one of a plurality of smart devices, generating a power resource schedule that includes at least one available power block associated with a power source, transmitting the power resource schedule to the resource manager of each of the plurality of smart devices, receiving at least one power request from a resource manager associated with at least one of the plurality of smart devices, the at least one power request including a requested available power block, allocating the requested available power block to the resource manager that sent the at least one power request, and sending an allocation indication to the resource manager that sent the at least one power request, the allocation indication indicating that the requested available power block has been allocated to the resource manager.

In an aspect, a method is provided for the orchestration and scheduling of access by a smart device to available power sources, the method comprising the steps of communicating with a resource orchestrator, receiving a power resource schedule from the resource orchestrator, the power resource schedule including at least one available power block associated with a power source, generating a power request that includes a requested available power block selected from the at least one available power block included in the received power resource schedule, the power request being generated at least in part on a power requirement of the smart device, sending the power request to the resource orchestrator, receiving an allocation indication from the resource orchestrator in the case that the resource orchestrator has allocated the requested available power block to the smart device, and instructing the smart device to access the power source associated with the allocated available power block based on the received allocation indication, wherein the allocated available power block determines an amount of allowed access to the power source by the smart device.

The foregoing aspects, and other features and advantages of the invention, will be apparent from the following, more particular description of aspects of the invention, the accompanying drawings, and the claims.

### BRIEF DESCRIPTION OF THE DRAWINGS

Details of one or more implementations of the subject matter of the invention are set forth in the accompanying drawings briefly described below and the related description set forth herein. Other objects, features, aspects, and advantages will become apparent from the description, the drawings, and the claims. Note that the relative dimensions of the drawings may not be drawn to scale. Like reference numbers and designations in the various drawings indicate like elements.

FIG. 1 is a top-level functional diagram of a resource orchestration system according to aspects of the invention;

FIG. 2a is a diagram depicting a power resource schedule for power resource blocks according to aspects of the invention;

FIG. 2b is a diagram depicting a power block description according to aspects of the invention;

FIG. 3 is a diagram depicting a power request according to aspects of the invention;

FIG. 4 is a ladder diagram depicting an exchange of messages between the resource managers of multiple smart devices and a resource orchestrator according to aspects of the invention;

FIG. 5 is a flowchart depicting a method for requesting power blocks by a resource manager in a smart device according to aspects of the invention;

FIG. 6 is a flowchart depicting a method for generating power resource schedules and allocating power blocks by a resource orchestrator according to aspects of the invention;

FIG. 7 is a functional diagram of a satellite comprised of common host functions and multiple hosted payloads according to aspects of the invention;

FIG. 8 is a functional diagram depicting a scheduled charging system of autonomous electric vehicles wherein each autonomous electric vehicle has an associated resource manager according to aspects of the invention;

FIG. 9 is a functional diagram depicting a residential neighborhood with power scheduling wherein each house has an associated resource manager according to aspects of the invention; and

FIG. 10 is a functional diagram depicting a house having an associated resource manager according to aspects of the invention.

### DETAILED DESCRIPTION

Aspects of the present invention and their advantages may be understood by referring to the figures and the following description. The descriptions and features disclosed herein can be applied to various devices, systems, software, and methods related to the orchestration and scheduling of scarce power related resources in a resource competitive environment.

The following terms are used herein and are defined as follows:

Smart Device—The intelligent device or thing that needs access to a power-related resource, such as for example an electric car, an autonomous vehicle, a factory robot, an appliance, a satellite hosted payload, etc. Smart Devices, in the context of this invention, have an associated resource manager as described herein.

Resource Manager (RM)—The power management system of a Smart Device which is responsible for power planning, management, and bidding on power-related resources.

Resource Orchestrator (RO)—The arbiter of power-related resources from one or more power sources to one or more power consuming Smart Devices. The Resource Orchestrator is responsible for conducting reservations and auctions for power-related resources.

Power Resource Schedule—A message from an RO to Smart Devices containing information needed by the RM to reserve, purchase, and/or bid on one or more power blocks.

Power Block—a unit of power-related resource being offered, bid upon, etc. This may include a quantity of power or energy, a start and end time of availability (or start time and duration) of the power-related resource, and connectivity.

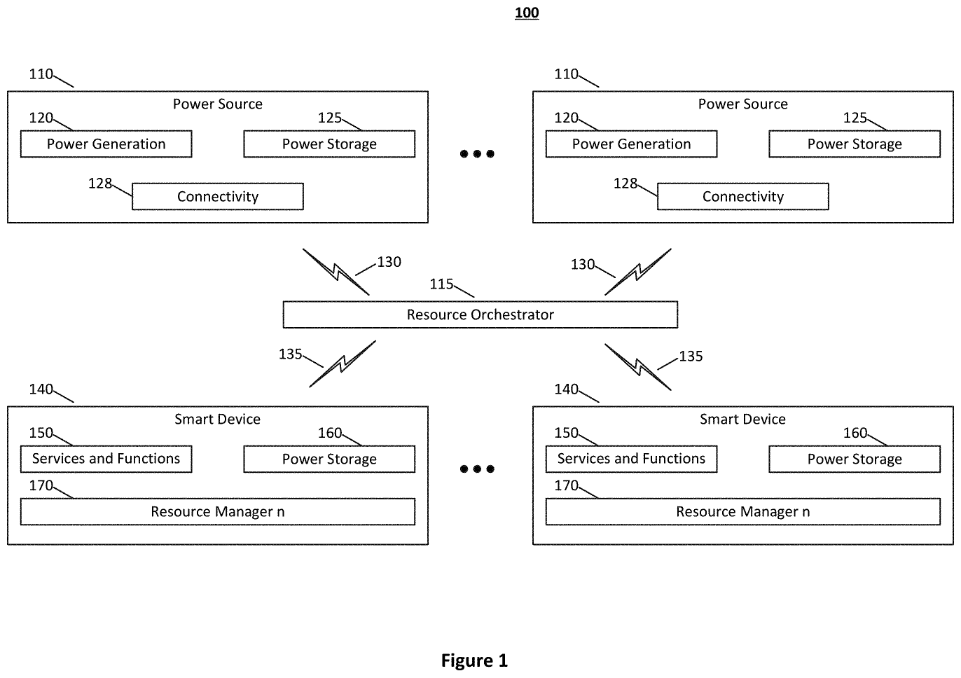

FIG. 1 depicts a system 100 in which Resource Orchestrator 115 arbitrates the availability and/or price of power from one or more power sources 110 to one or more Smart Devices 140. Each power source 110 has one or both of power generation 120 and power storage 125. For instance, if power source 110 is a natural gas-powered electricity generation facility, it may only have power generation 120. If power source 110 is a battery, it may only have power storage 125. If power source 110 is an intermittent power source such as a solar or wind power source, it may have power generation 120 which operates when the intermittent power is available and power storage 125, such as a battery or capacitor, which provides power when the intermittent power is unavailable. Power source 110 may also have a connectivity resource 128. For instance, if the Smart Device 140 is an autonomous electric vehicle or a warehouse robot, the scarce resource being scheduled may be an allotted time at the charging station rather than the electricity itself. However, if the Smart Device 140 always has connectivity to the power source 110, such as in a satellite with multiple sub-payloads, the scarce resource being scheduled may be power.

Resource Orchestrator 115 communicates with power sources 110 via source communication paths 130 to determine the availability of power, the price of power or other information. Source communication paths 130 can take many forms as would be known to one skilled in the art. For instance, if there is a single power source 110 in system 100, resource orchestrator 115 may be internal to power source 110 and communicate via local memory, an internal communications bus, etc. Alternatively, source communication paths 130 may be wireless communications such as Bluetooth, Wi-Fi, LTE 4G or 5G, or a proprietary method. Source communication paths may be wired communications such as cable or fiber optics. Messages on source communication paths 130 may be Internet Protocol (IP) packets.

Resource Orchestrator 115 communicates with the resource manager 170 in each of Smart devices 140 over device communication paths 135. Device communication paths 135 may take various forms depending upon the physical relationship between resource orchestrator 115 and Smart devices 140. For instance, device communications paths 135 could be a bus between a main satellite payload and sub-payloads. Device communication paths 135 could be any wired or wireless communication method as would be known to one skilled in the art. Further, resource manager 170 may be on servers or in data centers rather than residing wholly on smart device 140 or, alternatively, resource manager 170 may be distributed between servers and/or data centers and smart device 140.

In addition to resource manager 170, Smart device 140 is comprised of the functions and services 150 it provides and power storage 160. For instance, a satellite sub-payload may provide communications services, imagery, or sensors. Autonomous vehicles may provide ride share or package delivery services. Smart devices may store power they receive in power storage 160, such as for instance a battery or a capacitor.

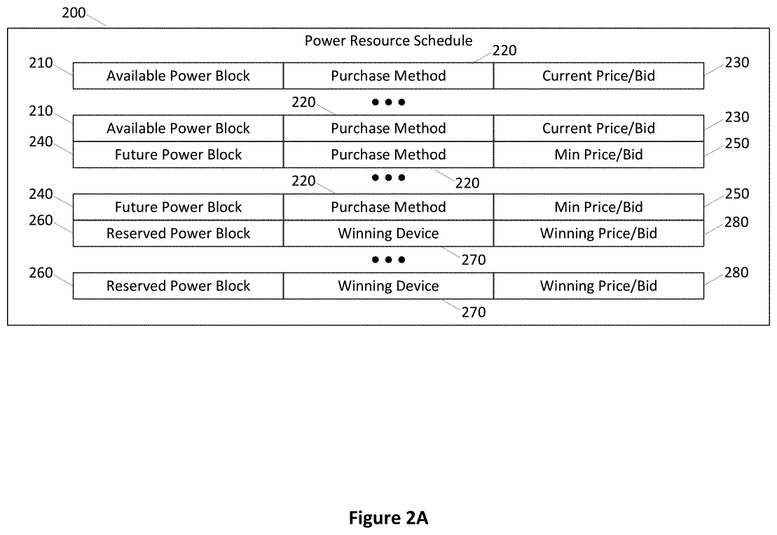

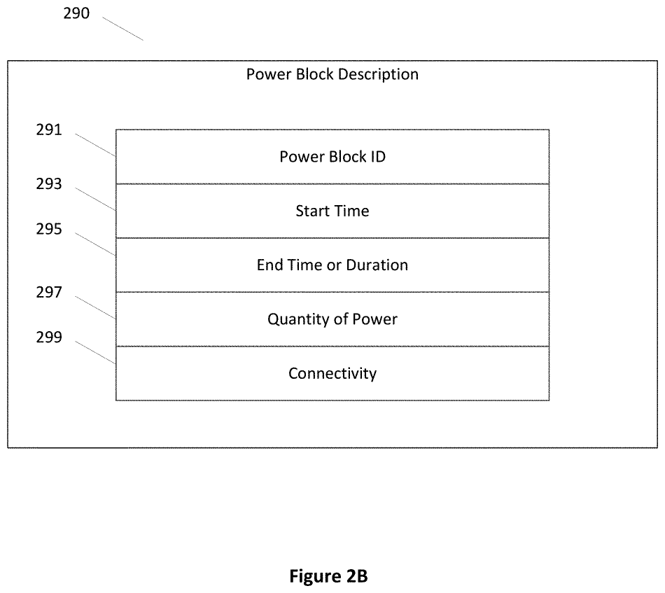

FIG. 2A depicts an embodiment of a power resource schedule 200. For each currently available power block, power resource schedule 200 contains a field identifying and describing each available power block 210. This field may take the form of a Power Block Description 290 as shown in FIG. 2B. As seen in FIG. 2B, Power Block Description 290 contains a power block identifier (ID) 291 for identification of the power block. Power Block Description 290 further contains the start time 293 of the power block and the end time or duration field 295. Optionally, power blocks can be of a fixed duration. In this case, the end time or duration field 295 would be optional. The quantity of power field 297 indicates the amount of power available beginning at start time 293 and lasting until the indicated, or known, duration. Power Block Description 290 optionally contains a connectivity field 299 describing the connectivity resource for receiving power, for instance which charger is assigned for the smart device, such as an autonomous vehicle or robot, to receive the power. For example, power block T437 may be defined as 1000 W of power starting at 12:00 UTC Jan. 10, 2022 for a duration of 5 minutes at charging station 3.

Returning to FIG. 2A, the parameters of each power block may be established a priori (e.g., during initial programming), updated periodically or asynchronously, or contained within a Power Block Description field 290 identifying the available power block 210 in the power resource schedule 200. For each available power block 210 identified within power resource schedule 200, there may be an associated field indicating the purchase method 220. The purchase method 220 may be a fixed-price reservation (e.g., first come, first served) or the purchase method 220 may be one or more forms of auction-based pricing. For example, purchase method 220 may be a field comprised of 3 binary bits with the representations shown in Table 1, below.

TABLE 1
Example Purchase Method Encodings

| Field Encoding | Purchase Method |
|---|---|
| b000 | Fixed, no price |
| b001 | Fixed Price |
| b010 | English Auction |
| b011 | Dutch Auction |
| b100 | First Price Auction |
| b101 | Second Price Auction |
| b110, b111 | reserved |

Alternatively, purchase method 220 may be known a priori and therefore is not contained in the power resource schedule 200. For each available power block 210 identified within power resource schedule 200, there may be an associated field indicating the current price or bid 230 that is required in order to be granted the power block. Each available power block 210 may also have associated with it the current high bidder (not shown) for that power block 210. In an aspect, current price/bid 230 may be a price indicator instead of an actual monetary value such as, for example, a code that indicates a monetary value or a monetary value range, or a pricing tier that indicates one of many pricing tiers.

Power resource schedule 200 may optionally contain fields identifying future power blocks 240, their purchase method 220, and their minimum price or bid 250. The field identifying future power blocks 240 may take the form of a Power Block Description 290.

The resource orchestrator 115 must indicate to the resource manager 170 of a smart device 140 which device power request was accepted causing the grant of the power block to that device. This may be accomplished by separate messaging or by broadcasting it in a subsequent power resource schedule 200. If contained in the power resource schedule 200, the power resource schedule includes the reserved power block identifier 260, an identifier of the winning device 270, and optionally the winning price or bid 280. If contained in a separate message that is unicast to the resource manager 170 of the winning smart device 140, this information includes the reserved power block identifier 260, optionally the identifier of the winning device 270, and optionally the winning price or bid 280. Reserved power block identifier 260 may take the form of a power block description 290 or power block identifier (ID) 291.

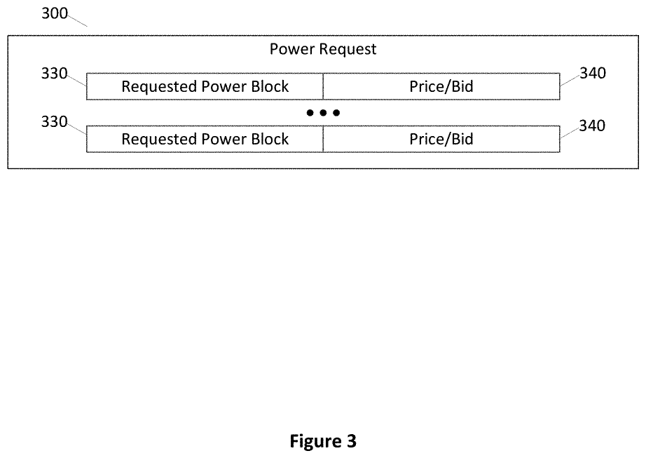

FIG. 3 depicts an embodiment of a power request 300. A power request 300 is a message by which a smart device 140 requests or bids for the reservation of one or more power blocks. A power request 300 contains an identification (e.g., T437, T438, T439) of one or more requested power blocks 330 that appeared as available power blocks 210 in a prior power resource schedule 200. Depending upon the purchase method 220 associated with each of the available power blocks 210 field in the prior power resource schedule 200, power request 300 may additionally contain a purchase price or bid 340. Power request 300 may also contain fields (not shown) that indicate that one bid is contingent on another. For instance, a smart device that needs only a single power block, or fewer power blocks than those indicated as being available in a power resource schedule, may provide a bid for both power blocks T437 and T438, but indicate that it wants T438 only if it does not win the bid for block T437.

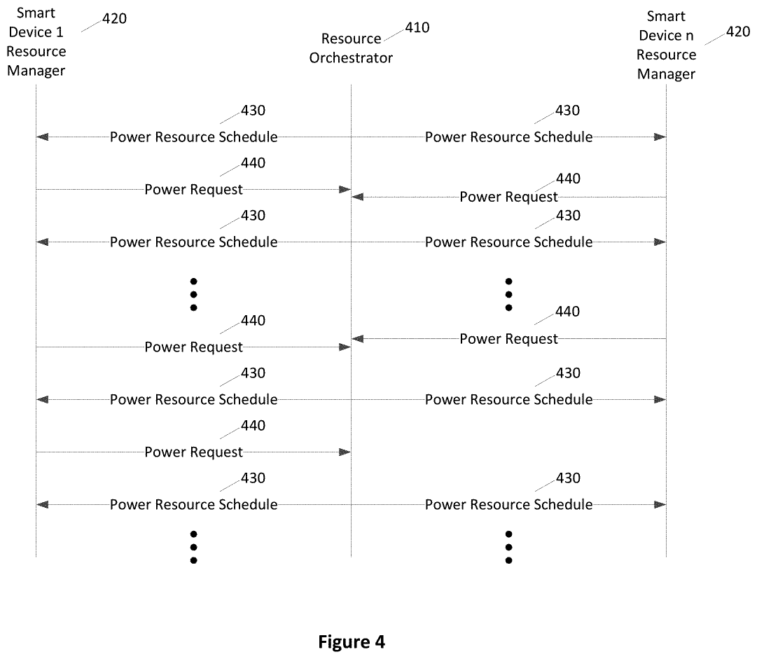

FIG. 4 is a ladder diagram depicting the exchange of messages between the resource managers 420 associated with multiple smart devices (1, n), respectively, and a resource orchestrator 410. Resource orchestrator 410 broadcasts power resource schedule 430 to the multiple resource managers 420. Alternatively, the resource orchestrator 410 may unicast or multicast the power resource schedule 430 to each resource manager 420 or group of resource managers 420. This would be useful, for instance, in a system in which different smart devices can use overlapping subsets of the available power blocks, but not all. For instance, a Brand A smart device may be capable of using power blocks supplied by a universal charger or a Brand A charger while a Brand B smart device may be capable of using power blocks supplied by a universal charger or a Brand B charger. Smart devices that differ based on capability, manufacturer or user/operator may receive different power resource schedules 410. Alternatively, a connectivity field 299 in power block description 290 of the power resource schedule 430 may contain information regarding physical connection type or compatibility.

In response to power resource schedule 430, resource managers 420 may issue power requests 440 in order to reserve power blocks. This protocol repeats as indicated by the ellipses in the diagram. If a resource manager 420 does not desire any of the available power blocks identified in the power resource schedule 430, it may refrain from sending a power request 440 in response to that power resource schedule 430. Alternatively, the resource manager 420 may respond with an empty power request 440 or a power request 440 that indicates it does not desire any of the currently available power blocks.

The protocol may repeat continuously with new power blocks being added into power resource schedule 430 as they become available, or the protocol may be performed for a specific set of blocks over a set period of time, repeating in a block fashion rather than continuously.

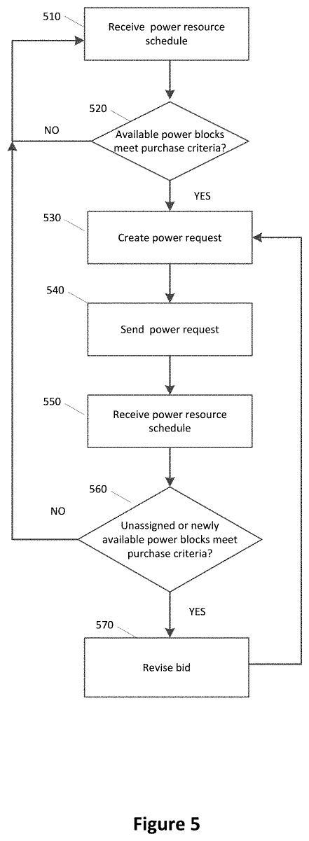

FIG. 5 is a flowchart diagram depicting a method implement by resource manager 140 in a smart device for requesting power blocks in response to receiving power resource schedules 200.

As seen in FIG. 5, at Step 510 the resource manager receives a power resource schedule from the resource orchestrator. The power resource schedule may be broadcast by the resource orchestrator or may be unicast to individual resource managers. If unicast, the power resource schedule may be transmitted in response to a request by the resource manager.

At step 520, the resource manager determines whether it will bid for one or more available power blocks in the power resource schedule if they meet the purchase criteria of the resource manager. As a part of this step, the resource manager may determine whether it is willing to pay the purchase price or minimum bid for the power blocks in the power schedule. For instance, P_{now} can be used to denote the current percent charge of the smart device's battery, P_{fetch} can be used to denote the power required by the smart device to obtain the power block, such as the power used by the smart device to travel to a charging station (as a percentage of full charge). P_{gap} can be used to denote the amount of power expected to be used by the smart device between now and when the power block is available, not counting P_{fetch} (as a percentage of full charge). Note that P_{gap} could be negative if the smart device already has power blocks reserved or has an alternate source of power such as a local solar array on a house. PRₘₐₓ can be used to denote the maximum price the smart device is allowed to bid, for instance via configuration. Then the price, PR_{bid}, that the smart device is willing to bid may be calculated by a cost function such as, for example:

PR_{bid}=MAX[1−(P_{now}−P_{fetch}−P_{gap}),0]*PRₘₐₓ Equation 1

One skilled in the art would understand that a non-linear equation may be used instead. The equation may contain other factors such as the availability of alternate power blocks or future power blocks that would meet the smart device's needs. The cost function may also take into account the current price of a power block. For instance, a smart device may be willing to make a high bid for a particular power block, but if the current price for that power block in the power resource schedule is very low (indicating low demand from other smart devices), then the smart device may bid an amount between PR_{bid} and the current price, such as the average or a weighted average of those two values.

If the resource manager does not want to make a request for any of the available power blocks, the process then returns to step 510 to await receipt of another power resource schedule. If one or more available power blocks meet the purchase criteria of the resource manager, the process proceeds to step 530. Whether or not an available power block meets the purchase criteria of the resource manager could be determined, for instance, based on whether or not PR_{bid} as calculated above is greater than or equal to the current price for the available power block as stated in the power resource schedule.

At step 530, the resource manager creates a power request indicating to the resource orchestrator which available power blocks the resource manager is interested in and including a price or bid, for instance PR_{bid}, the lower of PR_{bid} and the current price listed in the power resource schedule, or an average of the two, if required. At step 540, the resource manager transmits the power request to the resource orchestrator and awaits reception of subsequent power resource schedule(s) at step 550.

At step 550, the resource manager receives the subsequent power resource schedule. The power resource schedule received at step 550 may indicate the power blocks that were assigned to that resource manager based on the power request it created in step 530. It may also indicate those power blocks that were won by other resource managers. Alternatively, the power block assignments may be received by the resource manager via a separate message from the resource orchestrator. Power blocks assigned to the resource manager or to other resource managers may affect the price that the resource manager is willing to pay for available power blocks, for instance, based on whether all of the resource manager's power needs were satisfied or if none were satisfied. The power resource schedule received at step 550 may also include power blocks that are still available but have revised prices, for instance an increase in price due to auction activity. The power resource schedule received in step 550 may also include newly available power blocks.

At step 560, the resource manager determines whether any unassigned or newly available power blocks meet its purchase criteria. If at step 560 the resource manager determines that no available power block meets its purchase criteria, the process then returns to step 510 to await another power resource schedule. The resource manager determines whether any available blocks have a current price or bid that is within its price tolerance (i.e., the range of acceptable prices for a power block of given characteristics) or less than PRₘₐₓ for the particular power block. The price or bid the resource manager is willing to pay may be determined by either or both of currently available power blocks and future power blocks described in the power resource schedule. If at step 560 the resource manager determines that no power blocks have a current minimum price or bid that satisfy its purchase criteria for the particular power block, the process returns to step 510 to await another power resource schedule. If at step 560 the resource manager determines that at least one power block has a current minimum price or bid that is within its price tolerance or purchase criteria for that particular power block, the process proceeds to step 570.

At step 570, the resource manager revises its bid or creates a new bid for the at least one available power block that has a current minimum price or bid that is within its price tolerance for that particular power block, and the process returns to step 530 where the resource manager creates a new power request with a revised bid.

One skilled in the art would understand that this process flow may be applied to both auction pricing of power blocks and static pricing of power blocks. For instance, if static pricing of power blocks is used, a power request may include a request for only one of two or more substantially identical power blocks. For instance, either of two charging stations next to each other or two or more power blocks sequential in time may cause power blocks that are substantially similar from the point of view of a particular resource manager to be present in the power resource schedule. In this case, if the first power block requested is assigned to a different smart device, the resource manager of the current smart device may update its bid on a remaining power block from no bid to at least the minimum price.

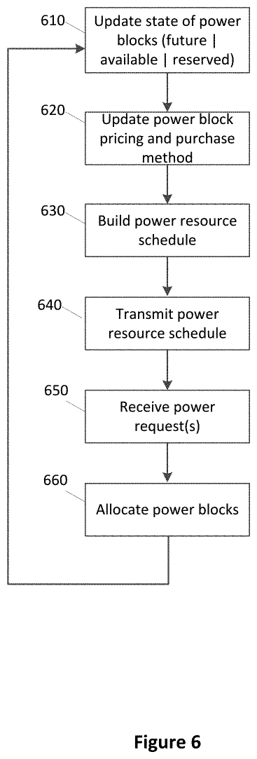

FIG. 6 is a flow diagram depicting a process that may be used by resource orchestrator 115 for generating power resource schedules and allocating power blocks. At step 610 the resource orchestrator updates the status of power blocks identifying those that are currently available and, optionally, those that are newly reserved. The update may optionally include identifying power blocks that will come available in the future.

At step 620, the resource orchestrator updates the pricing and the purchase method of the power blocks. This may be based, for instance on the auction style and rules governing price change from one auction round to the next as described in Table 2 below.

TABLE 2
Example Purchase Methods

| Purchase | | |
|---|---|---|
| Method | Description | Rounds |
| Fixed, no price | First bid wins, or random, or weighted round-robin choice of | one |
| | bidders. Price known a priori. | |
| Fixed Price | First bid wins, or random, or weighted round-robin choice of | one |
| | bidders. Price not known a priori. Price included in power | |
| | resource schedule. | |
| English Auction | Price increases until one bidder is left. Bidder pays bid price. | multiple |
| | If bidding reaches time limit or price limit, resolve with | |
| | random or weighted round-robin choice of bidders. | |
| Dutch Auction | Price decreases until at least one bidder accepts price. Bidder | multiple |
| | pays bid price. If more than one bidder accepts a price, | |
| | resolve with random or weighted round-robin choice of | |
| | bidders. | |
| First Price | Each bidder submits a single bid. Highest bidder wins and | one |
| Auction | pays highest bid price. If more than one tie for high bid, | |
| | resolve with random or weighted round-robin choice of | |
| | bidders. Could be used, for instance, to indicate the final | |
| | round of an English auction. | |
| Second Price | Each bidder submits a single bid. Highest bidder wins and | one |
| Auction | pays second highest bid price. If more than one tie for high | |
| | bid, resolve with random or weighted round-robin choice of | |
| | bidders. | |

For instance, in an English auction there may be set price increases applied when two or more smart devices are biding the same price, and there may be a maximum number of price increases after which the auction for a power block ends, possibly with a single round First Price auction indicating to smart devices that this is the final round. It should be noted that, as used herein, the English Auction and the Dutch Auction are modified from their “well-known” forms due to the fact that, unlike a tangible item like a painting for example, it is expected that a power block will cease to exist at some point in the future.

Power blocks are for power-related resources at a specific time and for a specific duration. Each power-related resource may have differing rules and pricing limits. For instance, power that is from a solar array may have rules and pricing that varies with the time of day and with the weather, while power that is from a battery may have rules and pricing that vary based on the battery's stored power and expected ability for the battery to recharge itself. Bidding may end when current time is within a certain time interval of the start time of the power block. At step 630, the resource orchestrator creates a power resource schedule, including any updated prices and any newly available power blocks or any new future power blocks.

At step 640, the resource orchestrator transmits the power resource schedule to the resource managers. The resource orchestrator may broadcast the power resource schedule or may unicast or multicast it. At step 650, the resource orchestrator receives any power requests transmitted by the resource managers. Step 650 may incorporate an intentional delay to allow for variations in each resource manager's reception and processing of power resource schedules and the transmission of power requests, including the possibility that a smart device may be in a low power, idle, or sleep state. At step 660, the resource orchestrator allocates any power blocks which have purchase requests that meet the price criteria for the purchase method used.

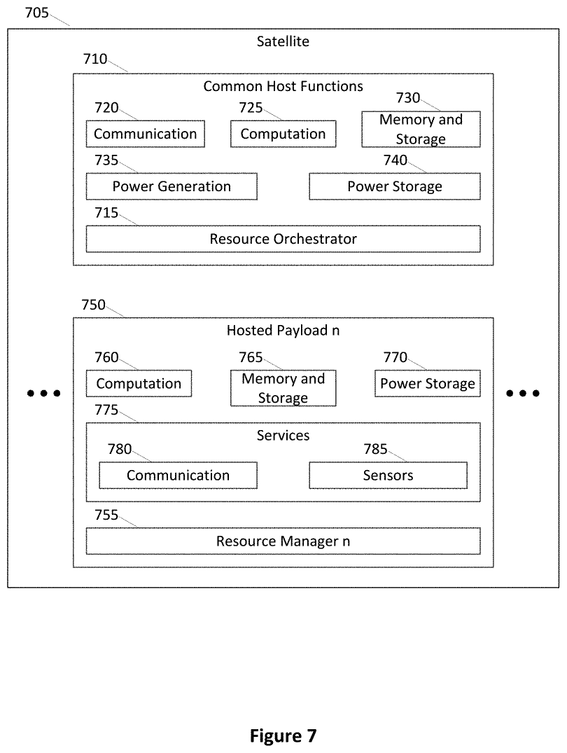

FIG. 7 depicts a satellite 705 comprised of common host functions 710 and multiple (n) hosted payloads 750. The common host functions 710 of satellite 705 may include functions such as communication 720, computation 725 and memory and/or disk storage 730. Additionally, common host functions include power generation 735, such as for example a solar array or a nuclear reactor, and power storage 740, such as for example a battery or a capacitor. Power available from power generation 735 and power storage 740 that is not needed to power the host satellite itself is available to define power blocks available to the hosted payloads 750. Resource orchestrator 715 creates available power blocks based on power available from power generation 735 and power storage 740.

Hosted payload 750 contains services 775, that are provided to one or more users, such as for example communication 780 and sensors 785. Services 775 may be supported by other resources such as computation 760 and memory and/or disk storage 765. Hosted payload 750 may have local power storage 770, such as a battery or a capacitor, that may be used to store power when resource orchestrator 715 offers power blocks from power generation 735 inexpensively, such as when power storage 740 is full. Resource manager 755 of hosted payload 750 communicates with resource orchestrator 715 to submit power requests to resource orchestrator 715 and to receive power schedules from resource orchestrator 715.

At times, power storage 740 may be a power source, but at other times power storage 740 may compete with hosted payloads 750 for power available from power generation 735. This may happen, for instance, if power storage 740 drops below a certain power level. This may be a simple diversion of power from power generation 735 to power storage 740, thereby reducing available power blocks, or power storage 740 may have its own resource manager that interacts with resource orchestrator 715 in order to compete for power blocks with the hosted payloads 750.

A resource orchestrator may need to share power between the smart devices and the infrastructure from which they receive power-related resources. For example, with respect to FIG. 7, Common Host Functions 710 must share available power between its own functions and those of Hosted Payloads 750. The overall power budget of satellite 705 may be split into baseline power and surplus power.

Baseline power is the minimum power required to operate critical functionality of satellite 705 and critical functionality of hosted payloads 750. Any baseline power not allocated to operate critical functionality of satellite 705 is apportioned across Hosted Payloads 750. The amount of baseline power apportioned to each Hosted Payload 750 may be different, including none. The baseline power provided to each Hosted Payload 750 may be fixed. Baseline power may depend on contracted service level agreements (SLAs) to Hosted Payload 750 prior to launch. Baseline power may be variable but known or predicted in advance due to variations in Hosted Payload 750 demand caused by orbital differences.

Surplus power is the excess power above the baseline supply that the Common Host Functions 710 can optionally provide to one or more Hosted Payloads 750. Surplus power may be the instantaneous, excess power available from the Common Host Functions 710 power generation system (e.g., solar cells) above the baseline power. Alternatively, surplus power may be greater than or less than the instantaneously available excess power due in part to the Common Host Functions 710 battery being either well charged or needing to be charged. This may be determined by prediction of future power generation capabilities and power demand.

The Common Host Functions 710 may offer the excess power to one or more Hosted Payloads 750 via the RO. The stated price may be static and known in advance or may be dynamic, based on the amount of surplus power and the Common Host Functions 710 battery state. The stated price may be a function of how far in advance the excess power block is purchased. For example, the stated price may be 25% lower if the excess power is purchased more than 8 hours in advance. The price may increase as the excess power block start time approaches, similar to hotel rooms or airline seats.

Auctions may set a minimum price, below which the surplus power may be used to charge the power storage 740 battery of Common Host Functions 710. The minimum price may be a function of the current state of the Common Host Functions 710 battery and/or the predicted future level of Common Host Functions 710 battery charging.

A Hosted Payload 750 Resource Manager 755 may establish a bid price depending on the economic value of receiving extra power. For example, the economic value may be based on whether the opportunity exists to.
Increase communication bandwidth, reduce latency, or increase reliability to existing customers.
Service new communication customers.
Increase the quantity or resolution of sensor data such as camera data.

A Hosted Payload 750 Resource Manager 755 may set a bid price depending on the state of its own current or future predicted battery charge level. A Hosted Payload 750 Resource Manager 755 may establish a bid strategy based on the historical price of excess power as a function of orbital position, season, or usage pattern.

For example, Hosted Payload 750 #1 may know that the excess power price generally goes down when the orbit position of Satellite 705 enters the Southern Hemisphere as there are fewer broadband service customers that Hosted Payloads 750 #2 and #3 can serve in that region. Since Hosted Payload 750 #1 has its own Power Storage 770 battery, it will bid on excess power during this time in order to maximize battery level in the most cost-effective manner.

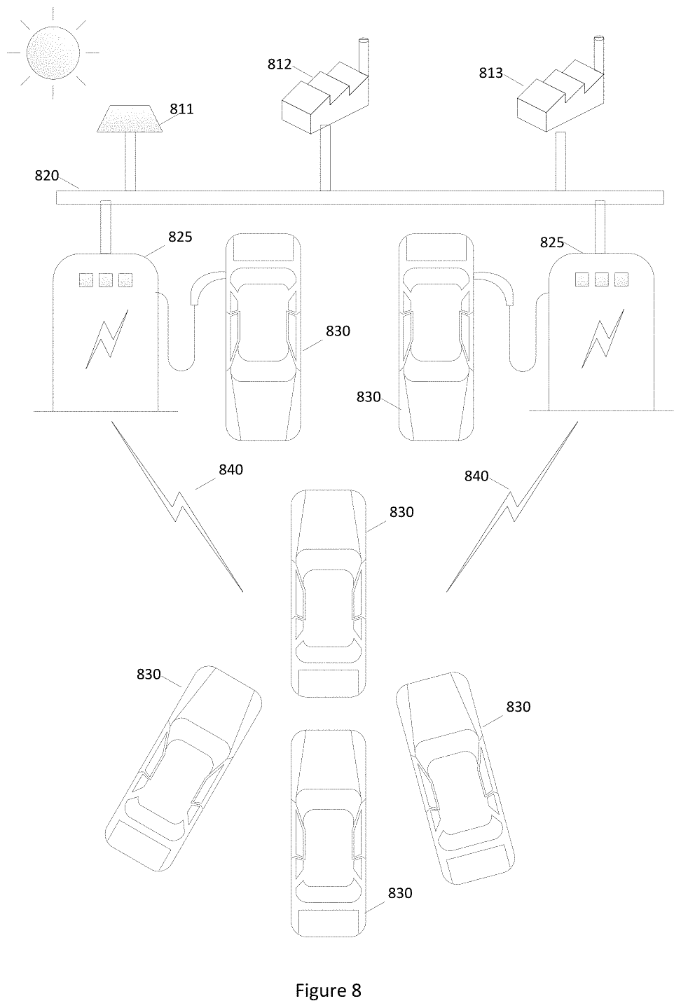

FIG. 8 depicts a system wherein autonomous electric vehicles 830 are acting as smart devices, such as smart device 140 of FIG. 1, each with an associated resource manager. Power blocks in this system are blocks of time at a charging station 825. Note that while electricity may be a scarce or variably priced quantity, such as when electric prices increase at peak hours, the connection to a charging station 825 is also a scarce, power-related resource and may be the power-related resource of primary concern to autonomous electric vehicles 830.

A resource orchestrator (not shown), such as resource orchestrator 110 of FIG. 1, controls the allocation of power blocks to the resource managers of the autonomous electric vehicles 830. The resource orchestrator may be provided on a server, in a data center, or may be distributed across one or more charging stations 825. The resource orchestrator may be controlled by the utility company, by the owner of the charging stations 825, or by the autonomous electric vehicle manufacturer. Other controlling authorities are possible as would be known to one skilled in the art. The resource orchestrator communicates with the resource managers of autonomous electric vehicles 830 via communication links 840 which may be any of a variety of wireless communication protocols such as vehicle-to-infrastructure (V2X) or mobile wireless (e.g., LTE 4/5G, Wi-Fi, etc.). The communication may be via a wireless connection with the charging station 825, via a cellular or broadband wireless connection to the resource orchestrator's controlling entity, or by any of a number of wireless endpoints that would be known to one skilled in the art.

Charging stations 825 are connected to electric grid 820. Electric grid may provide power from a variety of power sources such as solar power plant 811, natural gas fired power plants 812, or coal fired power plants 813. The availability of power from each source may be variable with some sources being available continuously and some, such as solar, being intermittent. Autonomous electric vehicles 830 may be willing to pay more for power generated by one source, for instance solar 811, than they would be willing to pay for power generated by another source, for instance coal 813. Accordingly, this information may be included in a power block description 290 for the particular power block.

Upon receiving a reservation for a power block, the winning autonomous vehicle 830 may be granted a token allowing it to use a specific charging station 825 for the time expressed in the power block description in the power resource schedule. The token would allow the autonomous vehicle 830 to connect with a specific charging station 825 or any charging station 825 in a set, for instance either of two collocated charging stations 825. One skilled in the art would understand that there are a variety of ways to generate such a token, including but not limited to nonfungible digital tokens derived though a blockchain.

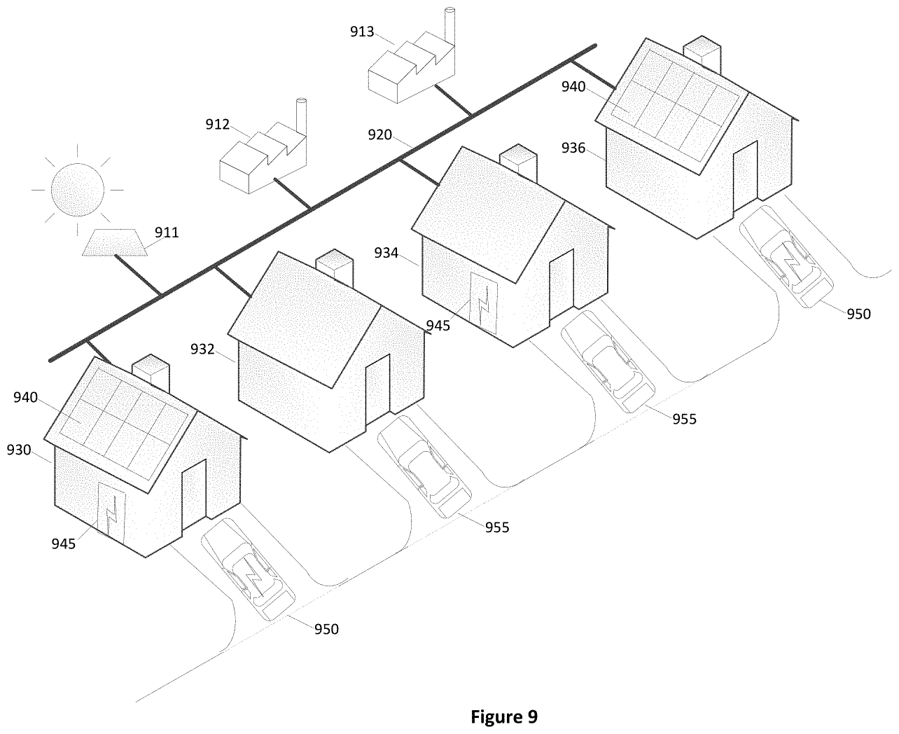

FIG. 9 depicts a group of houses 930, 932, 934, and 936, such as may be found in a neighborhood. Houses 930, 932, 934, and 936 are connected to power grid 920 which supplies electrical power from one or more sources, such as solar power plant 911, natural gas power plant 912, and coal power plant 913. A resource orchestrator (not shown), such as resource orchestrator 110, coordinates the pricing of power received by the houses. The resource orchestrator may be controlled by the power company, a power distribution company, or an independent entity. The resource orchestrator may reside on the controlling entity's facilities, may be hybrid edge-cloud based, or may be cloud based. Each of the houses has a resource manager, such as resource manager 140 of FIG. 1, in communication with the resource orchestrator. Each house's resource manager received power resource schedules from the resource orchestrator. The resource orchestrator may adjust power pricing to affect demand, for instance to prevent brownouts.

Houses 930, 932, 934, and 936 vary in their ability to generate and store power locally. For instance, there may be houses 930 that a have local renewable power sources such as a solar array 940 or a wind power generator as well as local battery storage 945. The resource manager of each house 940 may rely on their local solar array 940 and local battery storage 930 to take less power from power grid 920 when power resource schedules from the resource orchestrator indicate a higher price for electricity. Houses 930, 932, 934, and 936 may have a resource manager that manages demand via communication with networked home devices.

House 932 has neither a solar array nor local battery storage. It may have a resource manager that only manages power demand via communication with networked home devices.

House 934 has a local battery storage 945 but has no local power generation such as solar or wind. The resource manager of house 934, which may be built into local battery storage 945, may take advantage of low prices, for instance in the middle of the night, to charge local battery storage 945 when prices are low and use the stored electricity when prices are high, such as to run an air conditioning unit during peak usage hours.

House 936 has a solar array 940 but does not have local battery storage. The resource manager for house 936 may control smart appliances to run preferably when solar array 940 is generating sufficient power to supply a certain percentage of the power needs. That percentage may be dependent on the price of power indicated in the power resource schedules from the resource manager.

In all cases, each one of houses 930, 932, 934, and 936 may have smart appliances that have a resource manager and manage their power costs independently of the other appliances. For instance, electric cars 950 may conduct charging at home on a schedule determined by the home resource manager. In the alternative, each electric car 950 may have its own resource manager, such as with autonomous electric vehicles 830 of FIG. 8, that may conduct charging based on power resource schedules received from the power grid resource orchestrator while relying on a dedicated charging station at their associated house 930, 932, 934, or 936. In this latter case, the charging station at the house is not considered to be a scarce power-related resource. There may be other houses (not shown) that do not have a resource manager. The resource orchestrator must account for the demand of these houses when making power blocks available to houses 930, 932, 934, and 936.

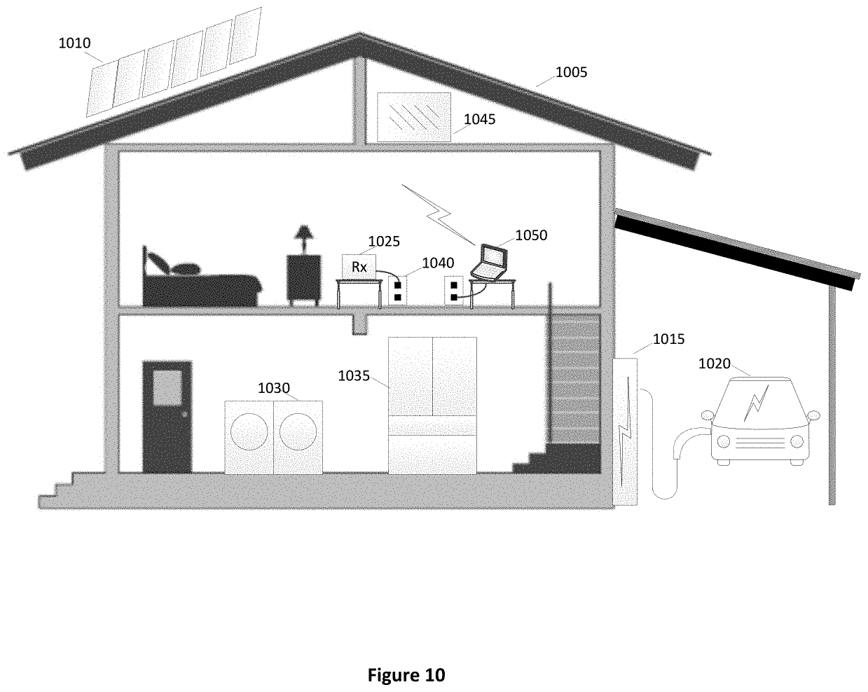

FIG. 10 depicts a house 1005 with resource manager 1050. Resource manager 1050 is in communication with a resource orchestrator (not shown) from which it receives power resource schedules and to which it sends power requests, as described previously with respect to FIGS. 2A, 2B, 3, 4, 6, and 9. The resource manager 1050 of house 1005 may reside on a computer or other communications-capable electronic device within the house. Resource manager 1050 may communicate with local power generation, such as solar array 1010. Resource manager 1050 may communicate with local power storage, such as battery 1015. Resource manager 1050 may communicate with appliances and objects that have some control of their power consumption such as electric vehicle 1020, air conditioner 1045, and smart refrigerator 1035. Resource manager 1050 may use controllable outlets 1040 to control power availability to devices such as washer and dryer 1030 or medical equipment 1025. Resource manager 1050 may communicate to other devices via wireless, for example Wi-Fi, or wired communications, such as data over power.

Resource manager 1050, in addition to acquiring power blocks for house 1005, may control the functioning of certain other devices in house 1005 when less power is reserved than may be needed to operate all devices in the house 1005 at full capacity, for instance when prices are too high, or a rolling brownout physically limits power availability. Resource manager 1050 may cause air conditioner 1045 or refrigerator 1035 to operate at a different temperature. Resource manager 1050 may ensure that smart outlet 1040 continues providing electricity to medical device 1025 while turning off a smart outlet 1040 that provides power to washer and dryer 1030. Resource manager 1050 may control the times when battery 1015 or electric vehicle 1020 recharge.

Appliances and smart devices such as electric vehicle 1020, air conditioner 1045 and smart refrigerator 1035 may communicate upcoming needs for power to resource manager 1050. Resource manager 1050 may take these future needs into account when determining how to create power request(s) so as to thereby maximize power availability for the needs of house 1005 while minimizing cost.

According to the aspects described above, devices, systems, methods, and processes are provided for the orchestration and scheduling of scarce power related resources in a resource competitive environment. Such power related resources may be orchestrated and scheduled for access and use by devices that include, for example, autonomous vehicles, factory robots, autonomous robots, satellite communications systems, satellite payload systems, residential smart devices, medical devices, and battery-supported rechargeable energy powered Internet of Things (IoT) devices.

Those of skill in the art will appreciate that the various method steps, illustrative logical and functional blocks, modules, units, and algorithm steps described in connection with the aspects disclosed herein can often be implemented as electronic hardware, application specific integrated chip (ASIC), computer software, or combinations of all. To clearly illustrate this interchangeability of hardware and software, various illustrative components, blocks, modules, and steps have been described above generally in terms of their functionality. Whether such functionality is implemented as hardware or software depends upon the particular constraints imposed on the overall system and devices. Skilled persons can implement the described functionality in varying ways for each particular system. Such implementation decisions are not a departure from the scope of the invention described herein. In addition, the grouping of functions within a unit, module, block, or step is for ease of description. Specific functions or steps can be moved from one unit, module, or block without departing from the invention.

Some or all of the various illustrative methods, algorithms, logical and functional blocks, units, steps and modules described in connection with the aspects disclosed herein, and in the accompanying figures, can be implemented or performed with a processor, such as a general purpose processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein and in the accompanying figures. A general-purpose processor can be a microprocessor, or can be any processor, controller, microcontroller, or state machine. A processor can also be implemented as a combination of computing devices, such as for example, a combination of a DSP and a microprocessor, a plurality of microprocessors, one or more microprocessors in conjunction with a DSP core, or any other such configuration.

Steps of a method or algorithm and processes of a block or module described herein and in the accompanying figures can be embodied directly in hardware, in a software module executed by a processor, or in a combination of the two. A software module can reside in RAM memory, flash memory, ROM memory, EPROM memory, EEPROM memory, registers, hard disk, a removable disk, a CD-ROM, or any other form of storage medium. An exemplary storage medium can be coupled to the processor such that the processor can read information from, and write information to, the storage medium. In the alternative, the storage medium can be integral to the processor. The processor and the storage medium can reside in an ASIC. Devices, blocks, or modules described as coupled may be coupled via intermediary devices, blocks, or modules. Similarly, a first device may be described as transmitting data to (or receiving from) a second device through intermediary devices that couple the first and second devices and the first device may be unaware of the ultimate destination of the data.

The above description of the disclosed aspects, and that provided in the accompanying documents, is provided to enable any person skilled in the art to make or use the invention. Various modifications to these aspects will be readily apparent to those skilled in the art, and the generic principles described herein, and in the accompanying documents, can be applied to other aspects without departing from the spirit or scope of the invention. Thus, it is to be understood that the description and drawings presented herein, and presented in the accompanying documents, represent particular aspects of the invention and are therefore representative examples of the subject matter that is broadly contemplated by the present invention. It is further understood that the scope of the present invention fully encompasses other aspects that are, or may become, understood to those skilled in the art based on the descriptions presented herein and that the scope of the present invention is accordingly not limited by the descriptions presented herein, or by the descriptions presented in the accompanying documents.

What we claim is:

1. A smart device that cooperates in the orchestration and scheduling of access to available power sources, the smart device comprising:
a communication unit;
a functional component that utilizes power; and
a resource manager that:
communicates, via the communication unit, with a resource orchestrator, receives a power resource schedule from the resource orchestrator, the power resource schedule including at least one available power block associated with a power source,
generates a power request that includes a requested available power block selected from the at least one available power block included in the received power resource schedule, the power request being generated at least in part on a power requirement associated with the functional component of the smart device, sends the power request to the resource orchestrator,
receives an allocation indication from the resource orchestrator in the case that resource orchestrator has allocated the requested available power block to the resource manager, and
instructs the smart device to access the power source associated with the allocated available power block based on the received allocation indication, wherein the allocated available power block determines an amount of allowed access to the power source by the smart device.

2. The smart device of claim 1, wherein the resource manager determines whether there is an available power block in the power resource schedule that meets at least one power block criteria of the resource manager and, in the case that an available power block in the power resource schedule meets the at least one power block criteria, the available power block is selected by the resource manager to be the requested available power block provided in the power request.

3. The smart device of claim 1, wherein the power request further includes a price bid parameter associated with the requested available power block.

4. The smart device of claim 3, wherein the power resource schedule further includes a price parameter associated with each of the at least one available power block, and wherein the price bid parameter included in the power request is based at least in part on the price parameter.

5. The smart device of claim 1, wherein the power resource schedule further includes a purchase method parameter associated with at least one available power block.

6. The smart device of claim 4, wherein the price parameter associated with each of the at least one available power block indicates a monetary value.

7. The smart device of claim 4, wherein the price parameter associated with each of the at least one available power block indicates a pricing code.

8. The smart device of claim 5, wherein the purchase method parameter associated with each of the at least one available power block indicates one of a fixed-price purchase method and an auction-based purchase method.

9. The smart device of claim 8, wherein, in the case that the purchase method parameter indicates an auction-based purchase method, the power resource schedule further includes a price parameter associated with each of the at least one available power block, the price parameter indicating one of a minimum bid amount, a current high bid received amount, and a winning bid amount.

10. The smart device of claim 1, wherein each available power block provided in the power resource schedule includes a power block description containing a power block identifier that is unique to the respective available power block.

11. The smart device of claim 10, wherein the power block description further includes a start time at which the respective available power block can be utilized.

12. The smart device of claim 10, wherein the power block description further includes one of a stop time and a time duration, each of which is associated with an amount of time that the respective available power block can be utilized.

13. The smart device of claim 10, wherein the power block description further includes a power quantity indication for the respective available power block to indicate an amount of power associated with the available power block.

14. The smart device of claim 10, wherein the power block description further includes a connectivity field for the respective available power block that indicates a connectivity resource by which the power source associated with the available power block can be accessed.

15. The smart device of claim 2, wherein the at least one power block criteria of the resource manager is a pricing criteria.

16. The smart device of claim 15, wherein the determination whether there is an available power block in the power resource schedule that meets the at least one power block criteria is based in part on whether a price parameter provided in the power resource schedule in association with the respective available power block satisfies the pricing criteria.

17. The smart device of claim 1, wherein the allocation indication is received by the resource manager in a subsequent power resource schedule transmitted from the resource orchestrator.

18. The smart device of claim 1, wherein a power source associated with the requested available power block in the power request is one of a charging station, a power generation device, a power storage device, and a direct power grid connection.

19. The smart device of claim 2, wherein the at least one power block criteria includes the power requirement associated with the functional component of the smart device.

20. The smart device of claim 3, wherein the price bid parameter included in the power request is based at least in part on a price criteria of the resource manager.

21. The smart device of claim 1, further including a power storage device that is operable to store power received by the smart device when accessing the power source associated with the allocated available power block.

22. The smart device of claim 1, wherein the smart device is one of an autonomous vehicle, a factory robot, an autonomous robot, a satellite communications system, a satellite payload system, a residential smart device, a medical device, and a rechargeable battery-powered Internet of Things (IoT) device.

23. A method for the orchestration and scheduling of access by a smart device to available power sources, the method comprising the steps of:
communicating with a resource orchestrator;
receiving a power resource schedule from the resource orchestrator, the power resource schedule including at least one available power block associated with a power source;
generating a power request that includes a requested available power block selected from the at least one available power block included in the received power resource schedule, the power request being generated at least in part on a power requirement of the smart device;
sending the power request to the resource orchestrator;
receiving an allocation indication from the resource orchestrator in the case that the resource orchestrator has allocated the requested available power block to the smart device; and
instructing the smart device to access the power source associated with the allocated available power block based on the received allocation indication, wherein the allocated available power block determines an amount of allowed access to the power source by the smart device.

24. The method of claim 23, further including the step of determining whether there is an available power block in the power resource schedule that meets at least one power block criteria and, in the case that an available power block in the power resource schedule meets the at least one power block criteria, the available power block is selected to be the requested available power block provided in the power request.

25. The method of claim 23, wherein the power request further includes a price bid parameter associated with the requested available power block.

26. The method of claim 25, wherein the power resource schedule further includes a price parameter associated with each of the at least one available power block, and wherein the price bid parameter included in the power request is based at least in part on the price parameter.

27. The method of claim 23, wherein the power resource schedule further includes a purchase method parameter associated with at least one available power block.

28. The method of claim 26, wherein the price parameter associated with each of the at least one available power block indicates a monetary value.

29. The method of claim 26, wherein the price parameter associated with each of the at least one available power block indicates a pricing code.

30. The method of claim 27, wherein the purchase method parameter associated with each of the at least one available power block indicates one of a fixed-price purchase method and an auction-based purchase method.

31. The method of claim 30, wherein, in the case that the purchase method parameter indicates an auction-based purchase method, the power resource schedule further includes a price parameter associated with each of the at least one available power block, the price parameter indicating one of a minimum bid amount, a current high bid received amount, and a winning bid amount.

32. The method of claim 23, wherein each available power block provided in the power resource schedule includes a power block description containing a power block identifier that is unique to the respective available power block.

33. The method of claim 32, wherein the power block description further includes a start time at which the respective available power block can be utilized.

34. The method of claim 32, wherein the power block description further includes one of a stop time and a time duration, each of which is associated with an amount of time that the respective available power block can be utilized.

35. The method of claim 32, wherein the power block description further includes a power quantity indication for the respective available power block to indicate an amount of power associated with the available power block.

36. The method of claim 32, wherein the power block description further includes a connectivity field for the respective available power block that indicates a connectivity resource by which the power source associated with the available power block can be accessed.

37. The method of claim 24, wherein the at least one power block criteria is a pricing criteria.

38. The method of claim 37, wherein the step of determining whether there is an available power block in the power resource schedule that meets the at least one power block criteria is based on whether a price parameter provided in the power resource schedule in association with the respective available power block satisfies the pricing criteria.

39. The method of claim 23, wherein, in the receiving step, the allocation indication is received in a subsequent power resource schedule transmitted from the resource orchestrator.

40. The method of claim 23, wherein a power source associated with the requested available power block in the power request is one of a charging station, a power generation device, a power storage device, and a direct power grid connection.

41. The method of claim 24, wherein the at least one power block criteria includes the power requirement of the smart device.

42. The method of claim 25, wherein the price bid parameter included in the power request is based at least in part on a price criteria.

43. The method of claim 23, wherein the smart device includes a power storage device that is operable to store power received by the smart device when accessing the power source associated with the allocated available power block.

44. The method of claim 23, wherein the smart device is one of an autonomous vehicle, a factory robot, an autonomous robot, a satellite communications system, a satellite payload system, a residential smart device, a medical device, and a rechargeable battery-powered Internet of Things (IoT) device.
